(19) United States
(12) Patent Application Publication
(10) Pub. No.: US 2005/0172310 A1
(43) Pub. Date: Aug. 4, 2005

(54) Processing application data in data broadcasting

(76) Inventor: Hung-Rok Kwon, Suwon-si (KR)

Correspondence Address: Robert E. Bushnell, Suite 300, 1522 K Street, N.W., Washington, DC, 20005-1202, US

(21) Appl. No.: 11/045,127

(22) Filed: Jan. 31, 2005

(30) Foreign Application Priority Data
Feb. 3, 2004 (KR) 2004-7060

(51) Int. Cl. H04L 12/66; G06F 15/173; H04H 9/00; H04N 7/16

(52) U.S. Cl. 725/9; 725/14; 709/224

(57) ABSTRACT

A system adapted to process data required by a bi-directional application in real-time in a digital data broadcasting based on the cable network includes: a data server adapted to collect data needed for data broadcasting and to transmit the data; a broadcasting station adapted to transmit an application including information on the data server; and a set-top box adapted to couple the application received from the broadcasting station to the data received from the data server in accordance with the information on the data server. A method of processing data required by a bi-directional application in real-time in a digital data broadcasting based on the cable network includes: transmitting an application including information on a data server from a broadcasting station to a set-top box; connecting a user to the data server to receive required data according to the information on the data server received from the broadcasting station; and coupling the data received from the data server to the application with the set-top box and providing the data, received from the data server and coupled to the application, to the user.

### CLAIM OF PRIORITY

This application makes reference to, incorporates the same herein, and claims all benefits accruing under 35 U.S.C. §119 from an application for THE SYSTEM AND METHOD FOR INTERACTIVE DATA PROCESSING ON CABLE BASED DATA BROADCASTING earlier filed in the Korean Intellectual Property Office on 3 Feb. 2004 and there duly assigned Ser. No. 2004-7060.

### BACKGROUND OF THE INVENTION

1. Field of the Invention

The present invention relates to processing data required by a bi-directional application in real-time in digital data broadcasting based on a cable network and, more particularly, to processing application data of data broadcasting in order to increase efficiency and rationality of bi-directional application data processing by separating the data from the application when processing the data.

2. Description of the Related Art

Recently, a rapid growth of the Internet has rapidly increased data traffic. While the data traffic via the Internet has doubled every 3 to 4 months, there is a limit to increasing the processing speed of the data traffic since the transmission speed of an existing telephone line is limited. On the other hand, since the broadcasting network has an advantage in that the broadcast transmission speed is faster than the Internet transmission speed because of its broad frequency band, and since the broadcasting network is capable of simultaneously transmitting the data to many end users, it is possible for everyone to surf and download through many channels in the sea of information. For example, if there is a satellite broadcast or a cable TV receiver having more than 50 channels, it is possible to transmit 750 Mbps per second through the broadcasting system, whereas it is possible to transmit about 20 Kbps per second through the Internet.

However, the Internet data transmission service has a limit in that a high performance phone line capable of a bi-directional connection is not sufficient. On the other hand, a broadcasting network using either terrestrial transmission, satellite transmission or cable transmission secures broad coverage so that it is possible for users located both near a metropolis and in an isolated area to have access to information.

In the past, it was not possible to couple the broadcasting system to the Internet since the broadcasting system was an analog system and the Internet is a digital system. However, since the broadcasting system is currently digitized, a new trial to couple the broadcasting system to the Internet is being made using data broadcasting.

While the data transmission in the age of analog broadcasting was a limited text transmission, various services are being provided through a TV set in the digital broadcasting age, such as e-mail, Electronic Program Guide (EPG), TV banking, telephone service, Internet searching, as well as information on weather and news. Such data broadcasting was developed and has evolved while providing new various services as its related applications are developed.

Consequently, the data broadcasting system in the digital age is defined as transmitting digital multimedia contents from one sender to a plurality of receivers (various terminals) using a broadcasting network, the data broadcasting network including services both interlocked and not with a program, or a service provided in an interactive form.

Data broadcasting systems can be variously classified according to whether or not an upward channel exists and whether or not a program is interlocked, and also according to the medium and data contents. In the past, the classification has generally been made according to whether or not the upward channel exists. It can be said that the upward channel is a useful classification standard to define a property of the data broadcasting service, since the data broadcasting service is different from the existing unidirectional service.

The data broadcasting service can be classified into two types according to whether or not the upward channel is used. The upward channel is a channel connected to a broadcast station from a receiver, which enables a network manager to personally provide customized service by transmitting user's information to the network manager. Also, it can be said that the upward channel is an essential condition to provide interactive TV service since it can reflect a user's response to the broadcasting communication.

Service without the upward channel is a mode where a broadcasting manager unidirectionally transmits information to a receiver without any interaction between the broadcasting network and the receiver as is in the existing broadcasting service. However, in the case of periodic transmission of data, that is, a data carousel scheme, or in the case in which the data has been previously downloaded into the hardware of a set-top box and then used, it is possible to partially simulate an interactive service with only an interaction between the receiver and the user. Such services include simple information related to a program or unidirectional transmission services such as a weather forecast, news information and stock information, which are mainly provided without the upward channel.

The service using the upward channel can make use of an interactive service which enables the user to request service to the broadcasting manager and to effect searching, storing and other various operations, when the upward channel from the receiver to the broadcasting network is provided.

When the upward channel is provided, it is possible to provide various services such as a high-speed Internet connection through a TV set, remote education, EPG, TV home banking, TV home shopping, and games as well as data reception. If some of the PC functions are added to the broadcasting terminal, the TV receiver will become an integrated information terminal that can perform various functions such as facsimile transmission, voice messaging, video conferencing, Web browsing, and e-mailing.

When the data broadcasting is classified according to whether or not the upward channel exists, it is easy to determine whether the corresponding service is a unidirectional service or an interactive service. That is, the unidirectional service is regarded as a push type service that is based on the assumption of passive viewers, whereas the interactive service has a pull type service that is based on the assumption of a viewer's participation.

In the periodic transmission of data, that is, in services provided in a carousel, a classification according to whether or not the upward channel exists may not be in accord with whether or not the user actively participates in the broadcasting. In the carousel method, the same data is periodically transmitted at predetermined intervals and the user receives the data after waiting for a data rotation period. While such a service is technically a unidirectional service, the users can feel that the service is provided by their choice.

On the other hand, on reviewing service types of data broadcasting, firstly, there is program interlocking type data broadcasting which is a service interlocked with the broadcasting program. Such data broadcasting corresponds to sports, dramas, games, and advertising broadcasting.

The next type is program independent type data broadcasting which a service using an independent channel without being interlocked with the broadcasting program, including EPG, weather, news, and so on.

Another type is an interactive service that provides educational services, shopping, e-mailing, and so on using the upward channel, and services not-tunable to the TV broadcasting. Such service includes educational services, shopping, banking, stock-market services, e-mailing, and so on.

Interactive service is a core service of data broadcasting in the digital age, which enables the users to perform information searching, storage and processing, and opinion expression through the upward channel. When the upward channel was introduced to broadcasting for the first time, a service of a simple viewer participation program level was suggested. However, educational services, e-mailing, telephone services, Internet searching, and so on are currently being developed and provided.

The developing data broadcast standard is divided into a Digital Video Broadcasting Multimedia Home Platform (DVB-MHP) of Europe and an Advanced Television Systems Committee—Digital TV Application Software Environment (ATSC—DASE) of the United States, and there is presently no internationally unified data broadcast standard.

The 1997 DVB published standards for data broadcast and interactive TV prescribes a method for transmitting data at a high speed through a satellite, a cable, and a terrestrial wave. Among them, a data broadcasting standard is DVB-data, and an interactive TV standard is DVB-I.

While the DVB-data and DVB-I do not consider versatility between markets, the DVD-MHP has been developed on the assumption that a formation of a horizontal market of such services will be accelerated by an increase of fusion of broadcasting, communications, computers and appliances.

The DVB-MHP has an object that a bi-directional service and an Internet connection service can be embodied in a receiver which receives home terminals such as an STB, PC, and other home digital networks as well as TV in consideration of the requirements of the users and the market, and to this end, a reference model has been defined by defining a standard receiver and a home appliance based on the standard interface between various businesses.

A data broadcasting system includes a broadcasting station having a data server, a carousel server, an application server, a digital broadcasting server, a multiplexer, and a set-top box.

The data server transforms written data broadcasting contents into a signal form suitable for a service and transmits the signal to the multiplexer. The data server prescribes a data service protocol, and also synchronizes time to a main program, generates service information, and schedules the program by controlling the digital broadcasting server to generate audio/video streams. Also, the data server is connected to a separate communication server for processing the viewer's requirements through the upward channel and provides the Internet service and services of various communication service providers.

The main function of the multiplexer is to time-division multiplex incoming audio/video signals from the digital broadcasting server and an incoming data signal from the data server and to transmit the multiplexed signals to the set-top box, that is, to a user. A scrambling function for limiting reception may be performed to prevent users other than the subscriber from accessing the multiplexer.

The carousel server forms an application format including data by receiving the data transmitted to the data server from the original data server and coupling the data to the application.

The application server retains an application including the data formed by the carousel server and transmits the application and the audio/video stream generated by the digital broadcasting server to the multiplexer.

The application is an application program executed on the basis of a Java Virtual Machine (JVM) in the digital broadcasting receiver. The application is transmitted from the broadcasting station and loaded into a digital broadcasting receiver after being tuned by a user's request.

Normally, a user who wants to have stock information has to receive the stock information that is arbitrarily transmitted from the broadcasting station. The data server of the broadcasting station collects data from a stock exchange that was the original data server.

The collected data is coupled with the application, and converted into a broadcast form by the carousel server and transmitted to the user. Consequently, the user receives and uses the application coupled to the data collected from the stock exchange from the broadcasting station.

In application conversion and transmission, a user receives and uses an application transmitted from a broadcasting station through a set-top box. However, it is noted that the received application is in a form including data.

That is, the application includes a typical execution file (*.exe file), a file used to indicate a property related with a setting of the application (*.cfg), an icon file (*.icon file) used to indicate a graphic, and a data file (*.data file) having data directly used by the user.

The application transmitted to the user from the broadcasting station finally reaches the user in a usable form through a conversion procedure. The conversion is performed in a carousel server.

The carousel server converts an object carousel into a data carousel with respect to the application and data transmitted to the user from the broadcasting station and finally broadcasts them in a form of a DSM-CC message through the application server. The DSM-CC message that reaches the user is finally restored to the original application after the data carousel has been converted into the object carousel through the set-top box.

The restored application containing data has a form that can be promptly used by the user as described above.

The DSM-CC (MPEG-2 Digital Storage Media Command and Control) refers to a message form of a transfer layer for a data service, which is a standard technology defined in the ISO/IEC13818-6. The 13818-6 is a standard technology of MPEG, which indicates a standard technology for structure and transfer methods of the carousel.

The data carousel includes data modules being periodically transmitted on a DVB versatile broadcasting network and a receiver for receiving the data module, and the object carousel includes a structured data group being transmitted to the user from the broadcasting server using objects such as a directory, a file, a stream, and so on.

That is, the data carousel is a mechanism for periodically transmitting the data module according to a DSM-CC User-to-Network Download protocol definition.

The object carousel is a mechanism for periodically transmitting the DSM-CC User-to-Network Object over the data carousel, which carries a hierarchy file structure using the DSM-CC U-U file/directory object.

The application transmitted from the broadcasting station was periodically transmitted to the user coupled with the data as described above.

The application executed according to the user's need in the bi-directional digital broadcasting is usually to provide specific information, that is, data. As described above, the data is periodically broadcast together with the application in the application server of the digital broadcasting station. That is, a carousel is accomplished.

A model in which the application and data are simultaneously processed can be referred to as a non-independent form. The non-independent form model is suitable for a unidirectional application structure, which has a complicated construction of the broadcasting station and has a limit for real-time data processing.

The non-independent model is a form in which the user determines and transmits the user's desired data in advance and does not fit a bi-directional application which transmits appropriate data according to a user's request.

Since data collected in advance is transmitted, when the user requires real-time data, the data is transmitted after carrying out a procedure of collecting and converting the appropriate data again. Accordingly, there is a limit in processing data required promptly in real-time.

Accordingly, since the application and data are usually in one server, the construction of the digital broadcasting station becomes complicated and there is a limit in processing data automatically so that an artificial data manipulation is required. Consequently, there was a problem in that it is difficult to perform real-time data processing.

### SUMMARY OF THE INVENTION

It is an object of the present invention to separate an application from data in bi-directional data broadcasting so that a broadcasting station transmits only application to a user and the user collects the data in real-time as needed, thereby processing the data in real-time.

According to an aspect of the present invention, a system is provided comprising: a data server adapted to collect data needed for data broadcasting and to transmit the data; a broadcasting station adapted to transmit an application including information on the data server; and a set-top box adapted to couple the application received from the broadcasting station to the data received from the data server in accordance with the information on the data server.

The data server is preferably coupled to the set-top box via a cable network.

The data server is preferably adapted to collect data related to the application from an original data server.

The broadcasting station is preferably adapted to transmit the application to a user via a carousel conversion.

The application preferably comprises an execution file, a property file, and a graphic file.

The property file preferably comprises server information.

The carousel conversion preferably comprises a procedure of converting the application into a message form.

The set-top box is preferably adapted to restore a message received from the broadcasting station to the application.

The set-top box is preferably adapted to transmit and receives the data via TCP/IP.

The set-top box preferably has a unique Internet Protocol (IP) address.

According to another aspect of the present invention, a method is provided comprising: transmitting an application including information on a data server from a broadcasting station to a set-top box; connecting a user to the data server to receive required data according to the information on the data server received from the broadcasting station; and coupling the data received from the data server to the application with the set-top box and providing the data, received from the data server and coupled to the application, to the user.

Transmitting an application preferably comprises performing a carousel conversion of the application with a carousel server.

The application preferably comprises an execution file, a property file, and a graphic file.

The property file preferably comprises server information for providing data.

The application preferably does not include a data file.

Data needed to perform a data service is preferably collected from an original data server by the data server.

Connecting a user to the data server preferably comprises: decoding data server information included in the application received from the broadcasting station; connecting to the data server according to the data server information; and receiving the user's desired data from the data server.

The data preferably comprises one of the data collected from a number of original data servers and stored.

Coupling the data received from the data server to the application preferably comprises: changing the data received from the data server to a file structure and coupling the file structure to the application with the set-top box; and coupling the data file changed to the file structure to the application and providing the user with the data file changed to the file structure coupled to the application with the set-top box.

The present invention relates to a system and method for processing real-time data required by a bi-directional application in digital data broadcasting based on a cable network, wherein the application and data can be separated and transmitted by making the data independent based on a TCP/IP so that the broadcasting station can transmit only the application, and the data can be processed in real-time by the user directly collecting the required data when needed.

### BRIEF DESCRIPTION OF THE DRAWINGS

A more complete appreciation of the prevent invention, and many of the attendant advantage thereof, will become readily apparent as the prevent invention becomes better understood by reference to the following detailed description when considered in conjunction with the accompanying drawings in which like reference symbols indicate the same or similar components, wherein:

FIG. 1 is a concept view of a data carousel in a data broadcasting service;

FIG. 2 is a view of a data broadcasting system;

FIG. 3 is a view of application conversion and transmission;

FIG. 4 is a view of a digital data broadcasting system in accordance with an embodiment of the present invention;

FIG. 5A is a view of an application transmitted in the broadcasting station;

FIG. 5B is a view of an application finally used by a user; and

FIG. 6 is a view of a set-top box in accordance with an embodiment of the present invention.

### DETAILED DESCRIPTION OF THE INVENTION

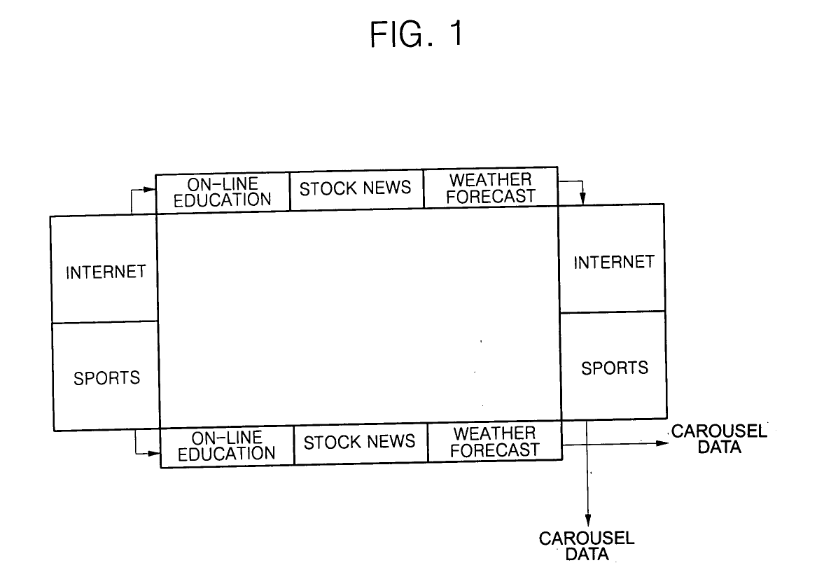

FIG. 1 is a concept view showing a data carousel in data broadcasting service.

As shown in FIG. 1, in the periodic transmission of data, that is, in services provided in a carousel, a classification according to whether or not the upward channel exists may not be in accord with whether or not the user actively participates in the broadcasting. In the carousel method, the same data is periodically transmitted at predetermined intervals and the user receives the data after waiting for a data rotation period. While such a service is technically a unidirectional service, the users can feel that the service is provided by their choice.

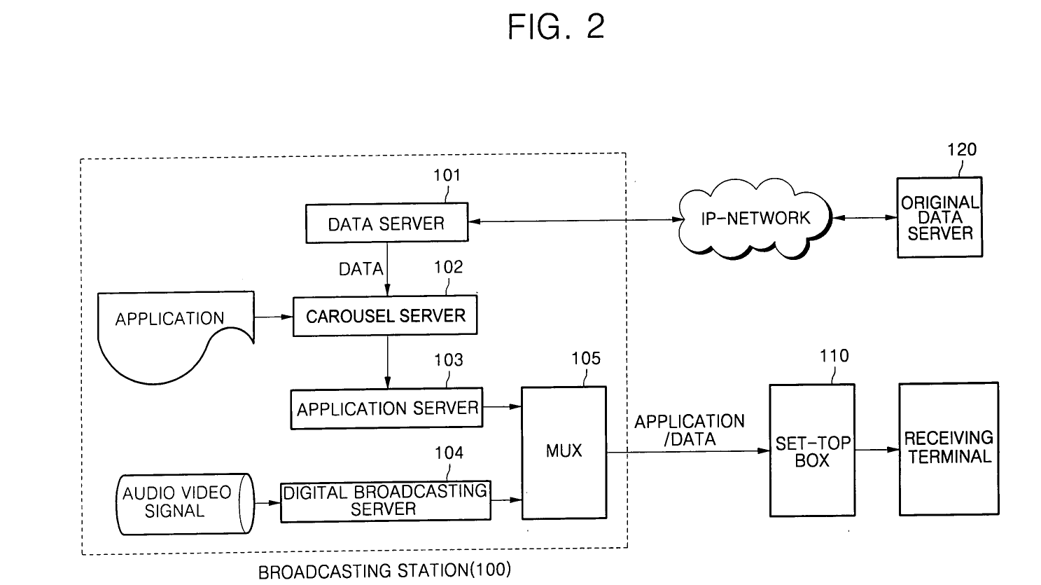

As shown in FIG. 2, data broadcasting system includes a broadcasting station 100 having a data server 101, a carousel server 102, an application server 103, a digital broadcasting server 104, a multiplexer 105, and a set-top box 110.

The data server 101 transforms written data broadcasting contents into a signal form suitable for a service and transmits the signal to the multiplexer 105. The data server 101 prescribes a data service protocol, and also synchronizes time to a main program, generates service information, and schedules the program by controlling the digital broadcasting server 104 to generate audio/video streams. Also, the data server 100 is connected to a separate communication server for processing the viewer's requirements through the upward channel and provides the Internet service and services of various communication service providers.

The main function of the multiplexer 105 is to time-division multiplex incoming audio/video signals from the digital broadcasting server 104 and an incoming data signal from the data server 101 and to transmit the multiplexed signals to the set-top box 110, that is, to a user. A scrambling function for limiting reception may be performed to prevent users other than the subscriber from accessing the multiplexer.

The carousel server 102 forms an application format including data by receiving the data transmitted to the data server 101 from the original data server 120 and coupling the data to the application.

The application server 103 retains an application including the data formed by the carousel server 102 and transmits the application and the audio/video stream generated by the digital broadcasting server 104 to the multiplexer 105.

The application is an application program executed on the basis of a Java Virtual Machine (JVM) in the digital broadcasting receiver. The application is transmitted from the broadcasting station and loaded into a digital broadcasting receiver after being tuned by a user's request.

Normally, a user who wants to have stock information has to receive the stock information that is arbitrarily transmitted from the broadcasting station 100. The data server 101 of the broadcasting station 100 collects data from a stock exchange that was the original data server 120.

The collected data is coupled with the application, and converted into a broadcast form by the carousel server 120 and transmitted to the user. Consequently, the user receives and uses the application coupled to the data collected from the stock exchange from the broadcasting station.

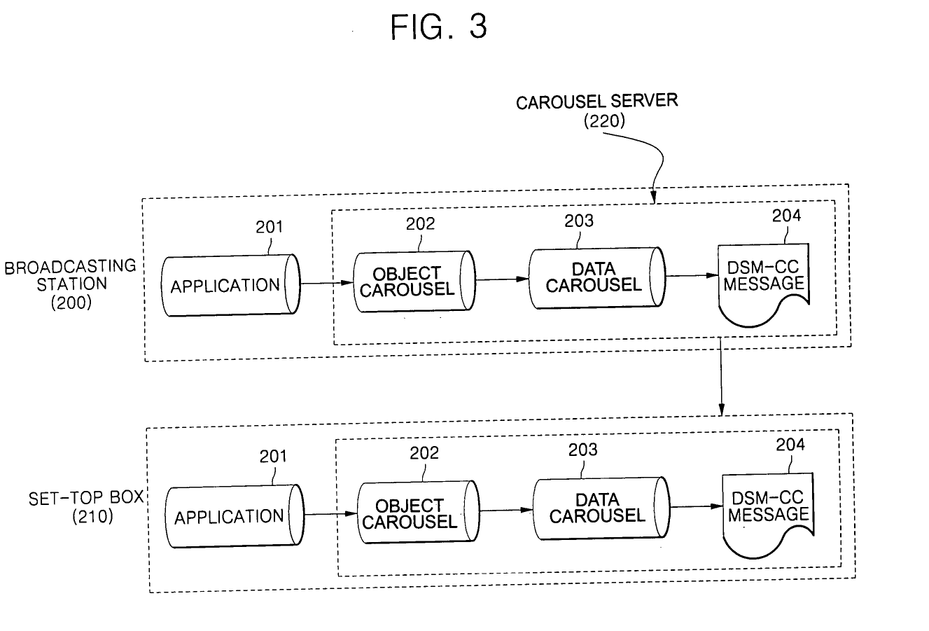

As shown in FIG. 3, in an application conversion and transmission, a user receives and uses an application 201 transmitted from a broadcasting station 200 through a set-top box 210. However, it is noted that the received application 201 is in a form including data.

That is, the application includes a typical execution file (*.exe file), a file used to indicate a property related with a setting of the application (*.cfg), an icon file (*.icon file) used to indicate a graphic, and a data file (*.data file) having data directly used by the user.

The application 201 transmitted to the user from the broadcasting station 200 finally reaches the user in a usable form through a conversion procedure. The conversion is performed in a carousel server 220.

The carousel server 220 converts an object carousel into a data carousel with respect to the application 201 and data transmitted to the user from the broadcasting station 200 and finally broadcasts them in a form of a DSM-CC message through the application server. The DSM-CC message that reaches the user is finally restored to the original application 201 after the data carousel has been converted into the object carousel through the set-top box 210.

The restored application containing data has a form that can be promptly used by the user as described above.

Hereinafter, a detail description of exemplary embodiments of the present invention will be given with reference to the accompanying drawings. In the following description of the present invention, when a detailed description of a known function or configuration unnecessarily make the gist of the present invention ambiguous, a detailed description thereof has been omitted.

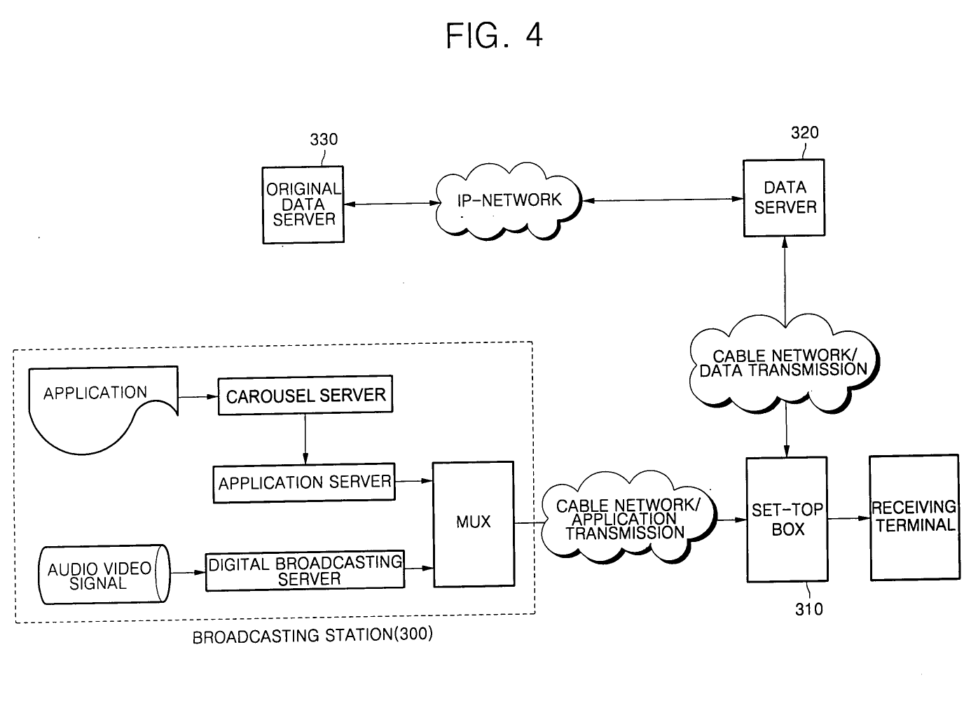

As shown in FIG. 4, a digital data broadcasting system in accordance with an embodiment of the present invention includes a digital broadcasting station 300 which broadcasts an application based on an Open Cable Application Platform (OCAP) or Multimedia Home Platform (MHP) applicable to a cable network, a set-top box 310 which supports a bi-directional application, and a data server 320 which controls the data transmission in accordance with a specific application's request.

The OCAP refers to middleware that is a standard of an application manufacturing basis for the bi-directional service in cable TV broadcasting. The OCAP can provide cable broadcasting with a web-based service so that it can support the user with a more advanced bi-directional service.

The MHP is a digital data broadcast standard under the Digital Video Broadcasting (DVB) standard, which is introducing the DVB-MHP as an Open Standard from many countries worldwide instead of its own technology. The MHP is a platform that is spreading at the highest speed, with which a system can be constructed with products made by a number of companies which observe the standard so that it is possible to flexibly meet system extension versatility and system maintenance management without being limited to products of a specific company.

In the present invention, the application and data are separated and transmitted so that the broadcasting station 300 transmits only the application, whereas the user directly collects his or her desired data so that real-time data processing can be performed.

Accordingly, the user directly collects the data from the data server 320 in accordance with the present invention, which is different from the conventional art. For example, in the case of stock information broadcasting, an application including data is received and used conventionally. On the other hand, the user can directly receive and use the stock information separated from the application, that is, only data from the broadcasting station data server 320, in accordance with the present invention.

In other words, the data server 320 of the broadcasting station 300 normally collects and stores necessary data from an original data server 330, and the user can collect and use desired data, for example, stock information by connecting to the data server 320 of the broadcasting station 300 when needed.

Even though the data server 320 is shown to be separated from the broadcasting station 300, it is a server operated by the digital broadcasting station 300, and the original data server 330 is a server which collects the data from the digital broadcasting station 300, for example, the original data server 330 is a server of the meteorological office in the case of the weather information.

Accordingly, the data server 320 of the broadcasting station 300 collects and stores various information, such as the stock information or the weather information from the original data server 330, and exchanges the information with the digital broadcasting set-top box 310so that the user can selectively use the desired data.

The present invention is based on the assumption of the data transmission and reception using the cable network being as described above. That is, the application reception from the broadcasting station 300 and the data reception from the data server 320 are accomplished by the cable network.

On the other hand, the application transmitted from the broadcasting station 300 does not include the data in order to realize the present invention.

In other words, the carousel server of the broadcasting station 300 converts the object carousel into the data carousel with respect to the application 201 and data transmitted to the user as in the conventional art. The converted application is finally transmitted to the user through the application server in a message form. A receiving terminal receives the message through the set-top box 310 and provides it to the user so that it is possible to effect a data service.

Conversion of the application performed in the carousel server of the broadcasting station 300 is performed without including the data as described above. The set-top box 310 performs reverse conversion with respect to the received message and then restores the message to the original application. This is a reverse procedure for the conversion performed in the carousel server, which is a kind of decoding procedure.

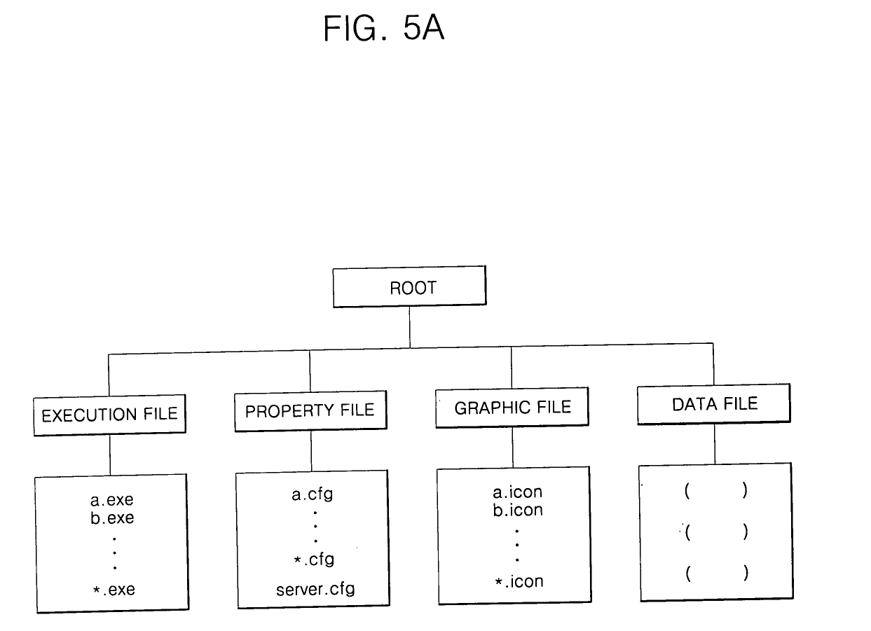

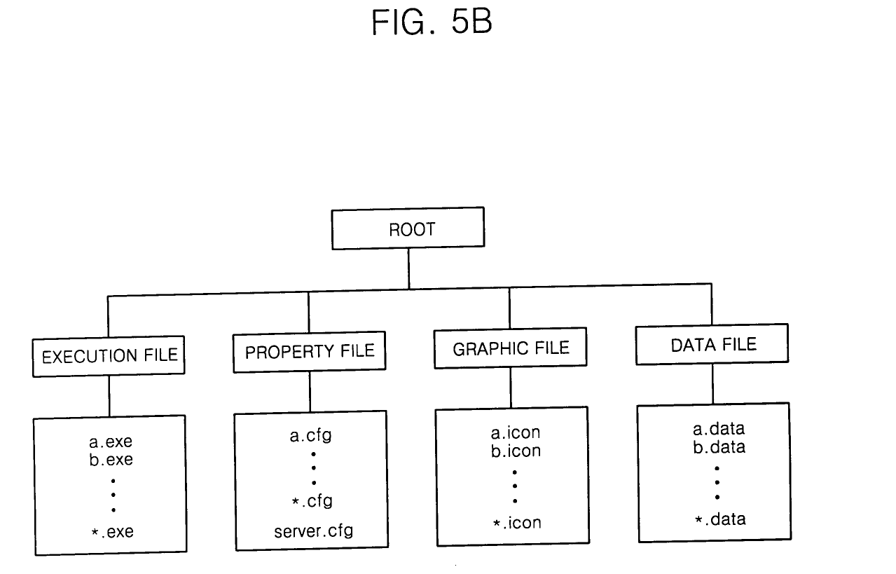

FIGS. 5A and 5B are views of applications in accordance with the present invention, wherein FIG. 5A is a view of an application transmitted from the broadcasting station 300, and FIG. 5B is a view of an application finally used by a user.

That is, the application in accordance with the present invention shown in FIG. 5A has a carousel construction consisting of only a normal execution file (*.exe file), property file (*.cfg), and an icon file(*.icon file) but does not have a data file (*.data file) as in the conventional method.

On the other hand, the property file in accordance with the present invention includes information on a data server 320 (server.cfg) with which the user can obtain the desired data. Accordingly, the set-top box 310 which has received the application can directly receive the necessary data from the data server 320 according to server information included in the application and make use of the data.

FIG. 5B is a view of the application which can be used finally, including a data file as shown here. The set-top box 310 confirms information on the data server 320 (server.cfg) included in the application received from the broadcasting station 300 as shown in FIG. 5A and decodes the information.

The set-top box 310 which confirmed and decoded the information of the data server 320 (server.cfg) communicates with the data server 320 and receives a user's desired data.

On the other hand, the broadcasting station 300 transmits a number of applications needed for the various services to the user. The data server 320 collects and stores the data needed for each application, in order to provide the user with the applications.

The set-top box 310 changes the received data to a structure of a data file and then couples the data file to the application so that the application is completed in a form which can be provided to the user.

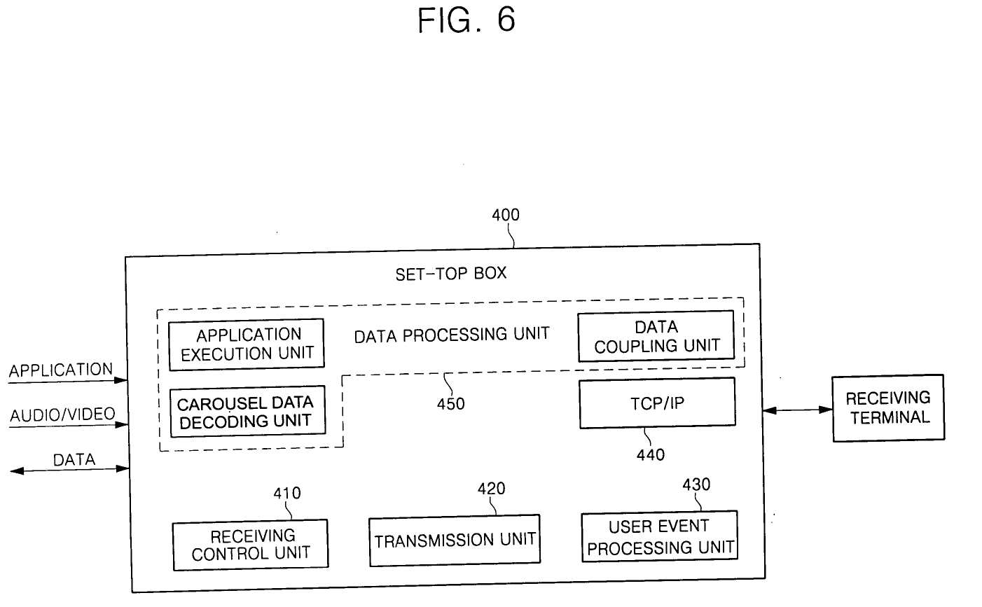

As shown in FIG.6, the set-top box 400 in accordance with an embodiment of the present invention is requested to perform a specific application by a receiving terminal, that is, the user (for example, a stock state). The set-top box 400 requested to perform the specific application drives a corresponding channel flowing the specific application through a user event processing unit 430, and receives the application from the broadcasting station through a reception control unit 410.

The application received from the broadcasting station is prepared for data coupling through the data processing unit 450. That is, the application received from the broadcasting station is converted to the original application data through a carousel data decoder in the data processing unit 450, and then requests an application execution unit to execute the application. The application execution unit is a kind of window manager, which executes the application.

The application execution unit recognizes the executed application as an independent model separated from the data and brings needed data from the data server. A data coupling unit couples the data brought from the data server with the application. The application is completed by being coupled to the data and then provides the user with the corresponding information through a terminal.

That is, in accordance with the present invention, the user receives the data broadcasting related application from the reception terminal by selecting a specific channel, and then receives the needed data by requesting the data when needed.

The data request is processed by a user's event processing unit 430 and then performed through a transmission unit 420. The set-top box 400 includes a TCP/IP stack 440 that enables the TCP/IP communication with the data server in order to bring the application and needed data from the data server.

The transmission unit 400 in the set-top box 400 consists of a return path, that is, a modem, and has to have a unique Internet address IP in order to individually perform the TCP/IP communication with the data server.

A detailed description of a typical data transmission and reception method of the set-top box 400 has been omitted for the sake of brevity.

Although exemplary embodiments of the present invention have been disclosed for illustrative purposes, those skilled in the art will appreciate that various modifications, additions and substitutions are possible without departing from the scope and spirit of the present invention as recited in the accompanying claims.

According to the present invention, in bi-directional application digital broadcasting, an application and data are separated so that the broadcasting station can transmit only the application and a user directly collects the data in real-time as needed, thereby processing the data in real-time.

1. A system comprising:
a data server adapted to collect data needed for data broadcasting and to transmit the data;
a broadcasting station adapted to transmit an application including information on the data server; and
a set-top box adapted to couple the application received from the broadcasting station to the data received from the data server in accordance with the information on the data server.

2. The system according to claim 1, wherein the data server is coupled to the set-top box via a cable network.

3. The system according to claim 1, wherein the data server is adapted to collect data related to the application from an original data server.

4. The system according to claim 1, wherein the broadcasting station is adapted to transmit the application to a user via a carousel conversion.

5. The system according to claim 1, wherein the application comprises an execution file, a property file, and a graphic file.

6. The system according to claim 5, wherein the property file comprises server information.

7. The system according to claim 4, wherein the carousel conversion comprises a procedure of converting the application into a message form.

8. The system according to claim 1, wherein the set-top box is adapted to restore a message received from the broadcasting station to the application.

9. The system according to claim 1, wherein the set-top box is adapted to transmit and receives the data via TCP/IP.

10. The system according to claim 1, wherein the set-top box has a unique Internet Protocol (IP) address.

11. A method comprising:
transmitting an application including information on a data server from a broadcasting station to a set-top box;
connecting a user to the data server to receive required data according to the information on the data server received from the broadcasting station; and
coupling the data received from the data server to the application with the set-top box and providing the data, received from the data server and coupled to the application, to the user.

12. The method according to claim 11, wherein transmitting an application comprises performing a carousel conversion of the application with a carousel server.

13. The method according to claim 11, wherein the application comprises an execution file, a property file, and a graphic file.

14. The method according to claim 13, wherein the property file comprises server information for providing data.

15. The method according to claim 11, wherein the application does not include a data file.

16. The method according to claim 11, wherein data needed to perform a data service is collected from an original data server by the data server.

17. The method according to claim 11, wherein connecting a user to the data server comprises:
decoding data server information included in the application received from the broadcasting station;
connecting to the data server according to the data server information; and
receiving the user's desired data from the data server.

18. The method according to claim 17, wherein the data comprises one of the data collected from a number of original data servers and stored.

19. The method according to claim 11, wherein coupling the data received from the data server to the application comprises:
changing the data received from the data server to a file structure and coupling the file structure to the application with the set-top box; and
coupling the data file changed to the file structure to the application and providing the user with the data file changed to the file structure coupled to the application with the set-top box.
